(19) United States
(12) Patent Application Publication
(10) Pub. No.: US 2011/0113555 A1
(43) Pub. Date: May 19, 2011

(54) Apparatus to facilitate the transfer of patients between support platforms

(76) Inventor: Richard A. Smith, Clarksville, MD (US)

(21) Appl. No.: 12/927,569

(22) Filed: Nov. 18, 2010

Related U.S. Application Data
(60) Provisional application No. 61/281,487, filed on Nov. 18, 2009.

(51) Int. Cl. A61G 7/10; A61G 13/00; A47C 21/04; A61G 7/012

(52) U.S. Cl. 5/601; 5/83.1; 5/603

(57) ABSTRACT

A patient care apparatus comprises a platform carrying a mattress configured to allow the care of and facilitate the transfer of a patient from one support platform to another support platform with minimal stimulation or disruption to the patient. The patient care apparatus further comprises of a base designed to allow the platform to be used on any stationary or mobile patient support platform including a mechanism for lifting the patient.

### RELATED APPLICATIONS

The present patent application is based upon Provisional Patent Application Ser. No. 61/281,487 filed Nov. 18, 2009 and the priority to that prior Provisional patent application is hereby claimed.

### BACKGROUND OF THE INVENTION

It is widely known that babies born prematurely with extremely low birth weights (ELBW) are at particular risk for intraventricular hemorrhage (IVH) during their early neonatal period due to both the vulnerability of the germinal matrix and the protective cerebral autoregulation which is present in older babies has not yet developed. Any event that results in disruption of vascular autoregulation can cause IVH making the higher in ELBW infants who are transported after birth.

Preliminary data for 2006 estimates 4,265,996 births occurred in the United States during the year, an increase of 3 percent from 2005, the largest single-year increase in the number of births since 1989, and the largest number of births since 1961. Preterm births (as defined before 37 weeks of gestation) have risen 21 percent since 1990 to 12.8 percent of the births during 2006. Infants born with Low Birth Weight (as defined as less than 2,500 grams) have risen 19 percent over this same period to 8.3 percent of births. The reviewed literature suggests the most vulnerable cohort of this population to be the very pre-term (less than 32 wks) and very low birth weight (less than 1,500 gms.) This suggests, at a minimum, between 63,136 and 85,319 births during 2006 in the United States were at risk for perinatal brain injury and was increased whenever they were required to be transported.

The current pathway for the care of a High Risk Premature Neonate generally requires the neonate to be moved into a minimum of three separate devices. Immediately upon birth, the newborn neonate is typically placed on an open bed radiant warmer (device number one) located in the birthing area and is assessed, possibly receiving some type of intervention such as resuscitation. The neonate is then moved into a transport incubator (device number two) and transported within the same hospital to a neonatal intensive care unit (NICU) where the infant is place in another thermal regulation device (device number three) where they are admitted for care.

Depending on the state of the facility, the infant may remain in this device for most of its care during the period of vulnerability. However, the infant may need to be transported again to another care facility using a transport incubator if the hospital in which they were born cannot provide the level of care required. They may also be moved to another thermal device during their care for another reason such as access or to have some procedure outside of the NICU.

During the past five years advances have been made in understanding perinatal brain injury and have led to an increased desire and need to monitor and image the neonate's brain. Imaging techniques include conducting Cranial Ultrasound and Magnetic Resonance Imaging (MRI) of the premature infant's brain. New thermal transport devices which are MRI compatible have also made it easier to transport the infant to and conduct the MRI by providing life support. However, clinicians are now forced to make difficult trade-offs between the value of an MRI and the added risk involved in moving a high risk premature infant. Clinicians are now challenged by how to access the neonate's head for examination, monitoring and imaging purposes with minimal disruption to the neonate.

Hospital's also have significant investments in existing patient support apparatus for the care of neonates. The goal of this invention is to provide a platform which allows clinicians to examine and, if necessary, move the high risk neonate between these apparatus in a stable method thereby reducing the disruption of vascular autoregulation. However, the invention may have use in other patient populations and is not to be limited to neonatal use.

### SUMMARY OF THE INVENTION

According to the present disclosure, a patient care apparatus comprises a patient support platform with a mattress and a means to allow clinicians to examine and, if necessary, move the patient support platform and mattress from one patient care apparatus to another patient care apparatus in a stable method reducing the disruption of vascular autoregulation. The patient care apparatus furthermore comprises of base in which the patient support platform and mattress will fit allowing it to be used in any patient care apparatus. The support base may be either custom tailored to a specific patient care apparatus or it may be adjustable allowing it to be used in multiple types of patient care apparatuses.

The patient care apparatus includes a mechanism to allow the patient support platform and mattress to be raised and, if required, lifted from the support base and moved in a level fashion from one patient care apparatus to another thereby causing minimal disruption to the patient.

As further features, the patient care apparatus may include support capabilities for such items as ventilator, feeding, and I.V. tubing, as well as other cables such as electrodes and sensors so they can easily move with the patient.

Further, the patient care apparatus may include the ability to transmit video and physiological data to clinicians who may be involved in the care of the high risk patient but are remotely situated to the patient.

Still further, the patient care apparatus may include a mechanism to allow its use during any type of imagining including the use of X-Ray cassettes and head coils for conducing MRIs.

As another feature of the present invention, the patient care apparatus can include a means to provide thermal support to the patient.

The drawings supplied in this disclosure represent one or more embodiments of the invention and are not meant to limit other embodiments of the inventions disclosed herein. These and other features and advantages of the present invention will become more readily apparent during the following detailed description taken in conjunction with the drawings herein.

### BRIEF DESCRIPTION OF THE DRAWINGS

FIG. 1 is a schematic view illustrating the possible movement of an infant within a health care facility using existing patient care apparatus;

FIG. 2 is an exploded view of an exemplary embodiment of the present invention and FIG. 2A is a perspective view of a generic support base;

FIG. 3 is a side view of a patient support platform of the present invention with the handles of the lifting mechanism in the upper, usable position;

FIG. 4 is a side view of the patient support platform of the present invention with the handles of the lifting mechanism in the lower, at rest, position;

FIG. 5 is a perspective view illustrating the use of the present invention to transfer an infant from one infant care apparatus to another infant care apparatus;

FIG. 6 is an enlarged, perspective view illustrating support capabilities of the lifting mechanism of the present invention;

FIG. 7 is a perspective view of an exemplary embodiment of the present invention illustrating one end of the patient support platform in a raised position;

FIG. 8 is a perspective view of an alternative exemplary embodiment of the present invention; and

FIG. 9 is a perspective view of the FIG. 8 embodiment illustrating the patient support platform in a raised, flat and level position and a removable head section.

### DETAILED DESCRIPTION OF THE INVENTION

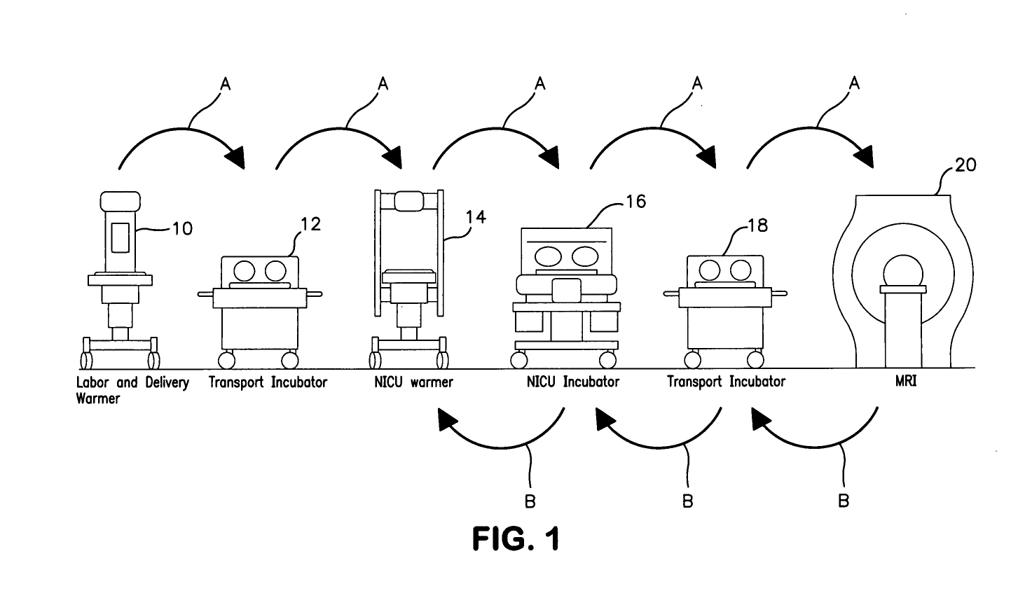

Referring now to FIG. 1, there is shown a perspective view illustrating the possible movements of an infant within a patient care facility. The movements of the infant are initially shown in the direction of the arrows A. As can be seen, the infant, immediately after birth, is typically placed on an open bed radiant warmer 10 located in the birthing area where the infant is assessed, possibly receiving some type of intervention such as resuscitation. The infant may then be moved into a transport incubator 12 and transported within the same health care facility to a neonatal intensive care unit where the infant is placed in another thermal regulation device, such as a NICU warmer 14 where the infant is admitted for care. Alternatively, or in addition, the infant may be placed into a NICU incubator 16.

Depending on the state of the facility, the infant may remain in the NICU incubator 16 for most of its care during the period of vulnerability. However, the infant may need to be transported again to another care facility using a transport incubator 18 if the hospital in which they were born cannot provide the level of care required. The infant may also be moved to another thermal patient care apparatus during its care for another reason such as access or to have some procedure outside of the NICU. It is also possible that the infant may be moved by means of the transport incubator 18 to a MRI apparatus 20 for further diagnostic testing. As can be seen by the arrows B, the infant may then be returned to a prior infant care apparatus such as the NICU incubator 16 or the NICU warmer 14 by means of the transport incubator 18.

As can therefore be seen, the infant potentially can be moved in a series of moves and be contained with a plurality of infant care apparatuses during its stay in the health care facility. As stated, each move is tedious to the infant and it would be desirable to make each move with as little trauma to the infant as possible.

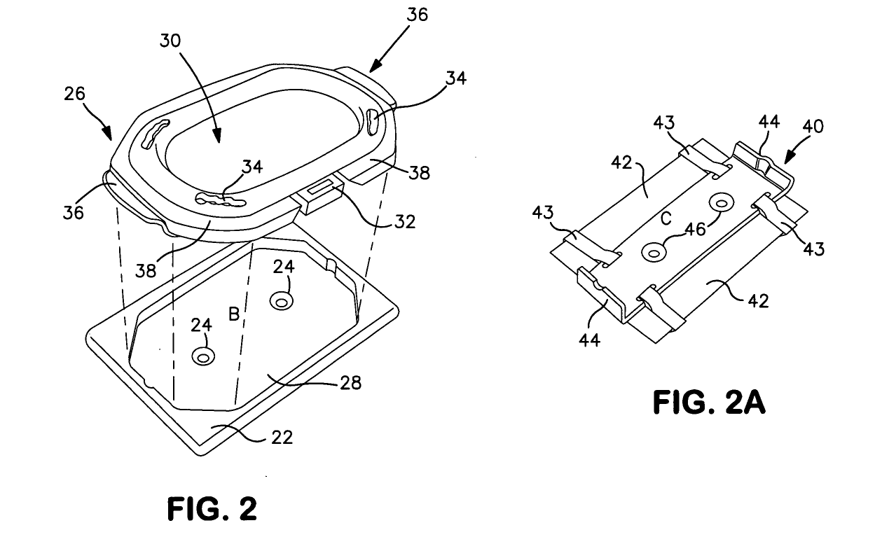

Turning then to FIG. 2, there is shown an exploded view of the present invention that is designed to be used with a specific patient support system, such as an incubator or infant warmer. As such, there is a support base 22 that is dimensioned so as to fit within an existing infant care apparatus, and, in particular, any of the various infant care apparatuses illustrated in FIG. 1. Within the support base 22 are locating features 24 that will be explained later but, it will be seen that the locating features 24 are, in the exemplary embodiment, indentations or projections in the support base 22.

As also can be seen in FIG. 2, there is a patient support platform 26 that fits into a similarly shaped indented area 28 in the support base 22 such that the patient support platform 26 can be firmly located within the indented area 28 in an immovable manner, that is, the patient support platform 26 does not move laterally once fitted into the indented area 28. As shown, the indented area 28 has diagonal corners, however, the indented area 28 can be any shape that can interfit with a conforming shaped patient support platform 26.

An infant mattress 30 is fitted within the patient support platform 26 for the comfort in supporting an infant thereon. In addition, there may be receptacles 32 located at the sides of the patient support platform 26 for securing straps (not shown) that retain the infant in position atop of the mattress 30. The securing straps may be joinable together by some affixing system such as the loop and hook system marketed under the mark Velcro. Other fastening systems can, however, be used, such as buckles, snap fasteners or the like.

There is also a supply system support 34 that is used to retain the various tubes or wires that are used to support the care being given to the patient when located atop of the mattress 30. Such tubes and wires may include wires for physiological electrodes as well as wires for sensors, IV lines, ventilation tubing, and feeding tubes.

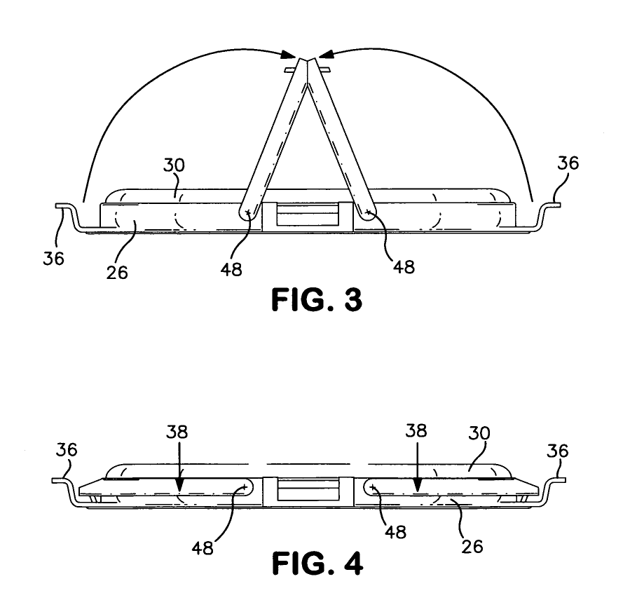

Also, there is a lifting mechanism that is used to physically lift the patient support platform 26 off of the support base 22 when it is desired to relocate the infant from one infant care apparatus to another, as illustrated in FIG. 1. The lifting mechanism can comprise a pair of fixed handles 36 located at both ends of the patient support platform 26 or can comprise a pair of pivotable handles 38 that can be moved between an at rest, lower position to an upper, usable position by the user. The pivotable handles 38 will be later explained with reference to FIGS. 3 and 4.

Turning now to FIG. 2A, there can be seen an exemplary embodiment of a generic support base 40 that can be used for any infant care apparatus since it is variable in dimensions. With this embodiment, the generic support base 40 has lateral sides 42 that are variable so as to vary the width of the generic support base 40 so as to interfit in any infant care apparatus. There are straps 43 that can be used to secure the lateral sides 42 to a center section 45 and be slidingly fitted beneath that center section 45. As such, the width of the generic support base 40 can be varied in accordance with the particular patient care apparatus and that same type of sliding adjustment may also be used to adjust the ends of the generic support base 40.

There are also locating features 44 at the ends of the generic support base 40 for guiding the generic support 26 when using the generic patient base 40. In addition, as can be seen, there are support location features 46 that interfit with the locating features 24 on the support base 22 so as to locate the generic support base 40 in the proper position.

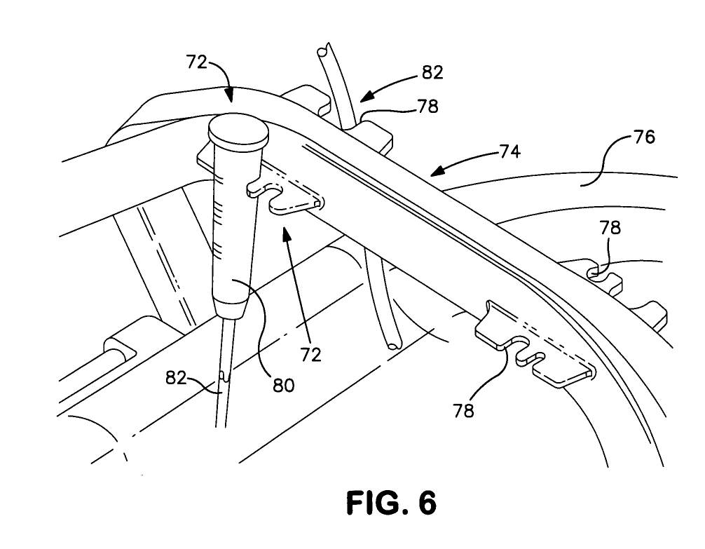

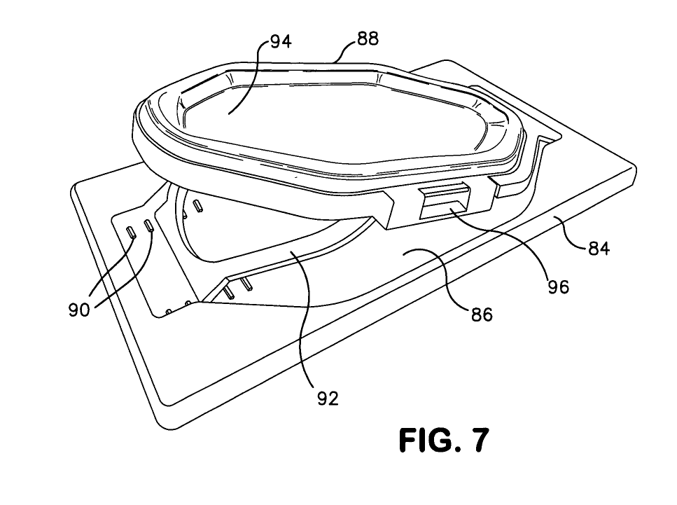

Turning then to FIGS. 3 and 4, there are shown, side views of the patient support platform 26 illustrating the use of the pivotable handles 38. As can be seen, the pivotable handles 38 are pivotally mounted at pivot points 48 such that the pivotable handles 38 are shown in their upper, usable positions in FIG. 3 and in their lower, at rest positions of FIG. 4. In the upper, usable position, the pivotable handles 38 can, of course, be used to lift and carry the patient support platform 26 and mattress 30 to relocate the infant from one infant care apparatus to another infant care apparatus. In this position, the pivotable handles 38 can also be used for a supply system support which will be later described in FIG. 6.

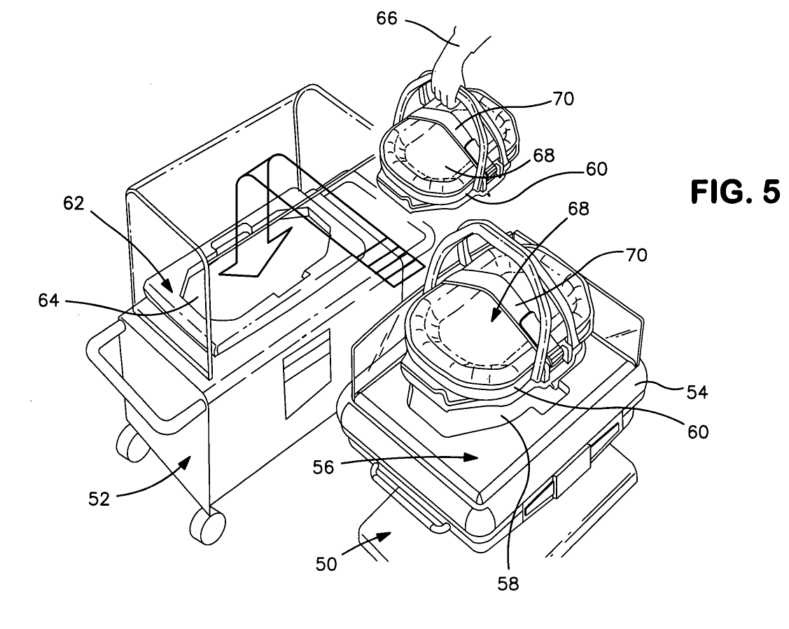

Next, referring to FIG. 5, there is shown a perspective view illustrating the relocation of the patient support platform 60 in order to relocate an infant from an infant warmer 50 to a transport incubator 52. As can be seen, the infant warmer 50 has a pedestal 54 with a support base 56 having an indented area 58 that is specially shaped to receiver the profile of the patient support platform 60. The same is true of the transport incubator 52 where there is a support base 62 having an indented area 64 that is of the same shape, that is, the indented area 64 also conforms to the bottom of the patient support platform 60.

Accordingly, as can be seen, the caregiver 66 can simply lift the patient support platform 60 upwardly to remove it from the indented area 58 of the infant warmer 60 to transport the infant to the indented area 64 of the transport incubator 52 easily and securely since the infant is retained in its position on the mattress 68 and secured therein by the straps 70. The transfer of the infant from one infant care apparatus to another infant care apparatus is thus is carried out with a minimum of disruption and trauma to the infant.

Turning next to FIG. 6, there is shown a perspective view of a portion of the present invention to illustrate a typical supply system support 72 that is incorporated into a handle 74 of the patient support platform 76. With the present supply system support 72, there are a plurality of U-shaped openings 78 in the handle 74 such that a supply device 80 and associate or other tubing 82 can be removable connected thereto such that as the patient support platform 76 is moved from one infant care apparatus to another infant care apparatus, the supply device 80 will be carried therealong and there is no need to disconnect many of the supply devices and tubing and then reconnect the devices when the infant has been relocated.

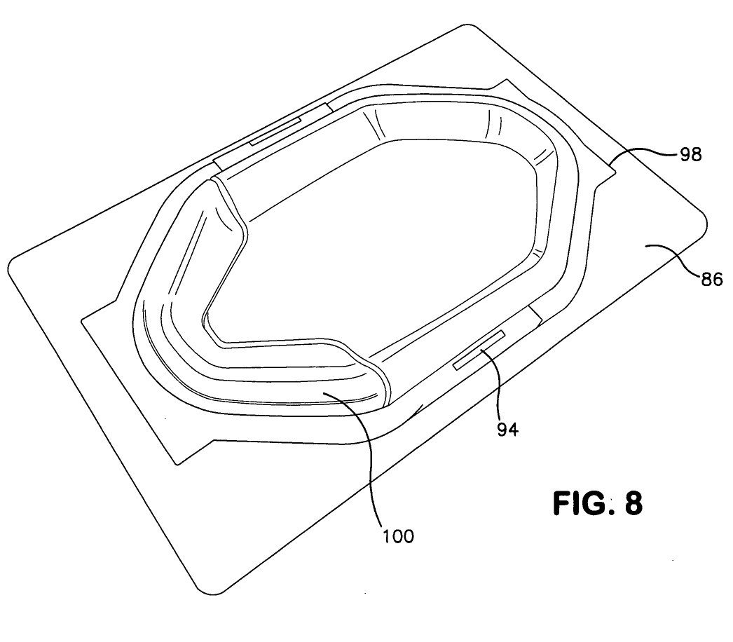

Turning then to FIG. 7, there is shown a perspective view of an exemplary embodiment which is adapted to be emplaced into an infant care apparatus as previously described. In this embodiment, the support base 84 can be seen and which has an indented area 86 that, again, conforms to the outer shape of the patient support platform 88. In this embodiment, however, the upper surface has a plurality of stops 90 formed thereon. The stops 90 can be molded into the indented area 86 and be depressions or protrusions that interact with the handle 92 so as to secure the distal end of the handle 92 according to a selected stop 90.

As can thus be seen, therefore, an end of the patient support platform 88 can be raised or lowered by selecting the particular stop 90 to retain the handle 92 at the desired location for the particular tilt angle. While the stops 90 are shown in FIG. 7 at one end of the support base 84, they are normally located at both ends such that the infant can be raised to a head up orientation (Fowler) or a head down orientation (Trendelenberg) while resting on the contoured infant mattress 94. The stops 90 can also be used to raise both ends of the support base 84 to a fully, level raised position to facilitate access to an infant.

In FIG. 7, there can be seen the safety strap receptacle or tie down 96 used to secure the safety straps to retain the infant safely in place on the patient support platform 88. The corresponding safety strap tie down oppositely located along the other lateral side of the patient support platform is not shown in FIG. 7.

As such, therefore, the handle 92 or handles 92 can be used both for lifting the patient support platform 88 from the infant care apparatus as well as to position the infant in a plurality of tilt angles or raised levels desired by the caregiver for a number of reasons such as Trendelenberg or Fowler positions or for easier access in conducting examination of the infant.

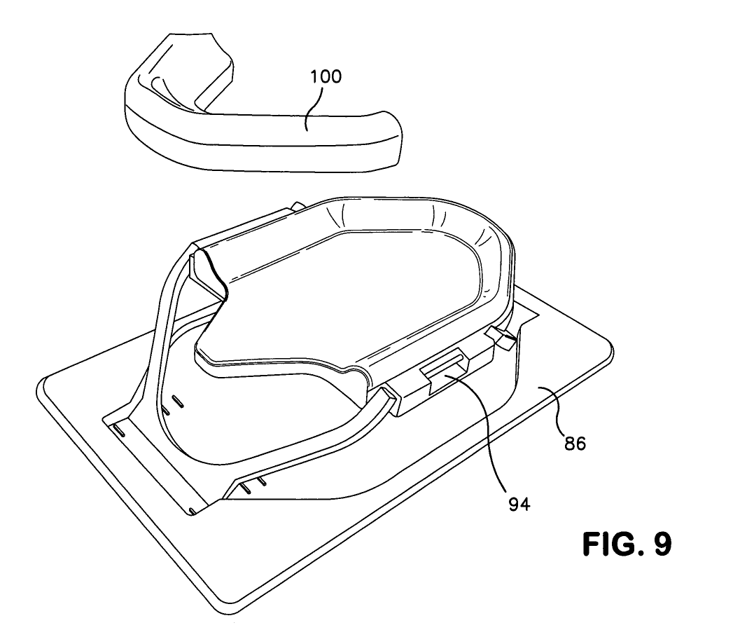

Turning then to FIGS. 8 and 9, there is shown perspective views of a further exemplary embodiment of the present invention and wherein the patient support platform 98 has a removable head section 100 that can be removed for better access to the infant's head for cranial ultrasound imaging and other neurological procedures. The removable head section 100 has a V-shape facing the head of the infant and has an outer contour complementary to the normal shape of the patient support platform 98 so as to fit within the indented area of the support base 84. Furthermore, FIG. 9 illustrates the patient support platform 98 raised and level and with the head section 100 removed allowing better access to the patient's head.

The materials for construction of the patient support platform of the present invention can be those that are non-magnetic or compatible with all imaging devices such as MRI and X-ray apparatus and the patient support platform can accommodate a coil for a MRI apparatus. Types of compatibility include combined EM fields (static magnetic, gradient magnetic, and/or radio frequency) and attachment of head coils or use of X-ray trays.

Those skilled in the art will readily recognize numerous adaptations and modifications which can be made to the infant care apparatus of the present invention which will result in an improved infant carrying structure and infant care apparatus utilizing the same, yet all of which will fall within the scope and spirit of the present invention as defined in the following claims. Accordingly, the invention is to be limited only by the following claims and their equivalents.

What is claimed is:

1. A patient care apparatus comprising a support base for supporting a patient, the supporting base having an indented area,
a patient support platform adapted to fit within the indented area and having a mattress positioned thereon, the patient support platform begin removable from the indented area,
a lifting mechanism, adapted to be grasped by a caregiver to remove the patient support platform from the indented area.

2. The patient care apparatus as defined in claim 1 wherein the patient support platform is shaped to conform closely with the shape of indented area of the supporting base to prevent lateral movement between the patient support platform and the indented area when the patient support platform is positioned within the indented area.

3. The patient care apparatus as defined in claim 1 further including support location devices located on the supporting base and the patient support platform that align together to correctly position the patient support platform on the supporting base.

4. The patient care apparatus as defined in claim 1 wherein the lifting mechanism comprises a pair of handles pivotally affixed to the patient support platform.

5. The patient care apparatus as defined in claim 1 wherein the support base has a plurality of stops provided thereon and one of the handles can be abutted against one of the plurality of stops to determine a tilt angle of the patient support platform.

6. The patient care apparatus as defined in claim 5 wherein the support base has a plurality of sets of stops provided along the support base at opposite ends thereof and each of the handles can be abutted against a stop of one of the sets of stops to adjust the tilt angle of the patient support platform.

7. The patient care apparatus as defined in claim 1 further including an attachment system support device affixed to the patient support platform.

8. The patient care apparatus as defined in claim 7 wherein the attachment system support device is molded into a handle affixed to the patient support platform.

9. The patient care apparatus as defined in claim 1 wherein the patient support platform is comprised of materials that are compatible with the use of imagining apparatus, including MRI and x-ray apparatus.

10. The patient care apparatus as defined in claim 1 wherein the patient care apparatus is an infant care apparatus that provides thermal support to a patient positioned therein.

11. The patient care apparatus as defined in claim 1 wherein the patient support platform has a head section at one end thereof that is removable for full access to the head of an infant positioned on the patient support platform.

12. A method of moving a patient for one patient care apparatus to another patient care apparatus comprising the steps of:
providing a supporting base having an indented area in one patient care apparatus and a patient support platform securely fitted within the indented area, the patient support having a mattress adapted to securely hold an infant;
removing the patient support platform holding the infant from the one patient care apparatus; and
moving the patient support platform with an infant secured thereto to another patient care apparatus and positioning the patient support platform into an indented area of the another patient care apparatus.

13. The method as defined in claim 12 wherein the step of providing a patient support platform comprise providing a patient support platform having a lifting mechanism and the step of removing the patient support platform comprises using the lifting mechanism to remove the patient support platform from the one patient care apparatus.

14. The method as defined in claim 12 wherein the step of providing a patient support platform having a lifting mechanism comprises providing a patient support platform having a lifting mechanism comprised of two pivotable handles.

15. A patient support platform comprising a molded base having a mattress atop of the molded base, a bed height adjusting system for adjusting the height of the patient support platform, a receptacle located at each lateral side of the patient support platform, a pair of straps extending from the receptacles and adapted to be joined together to secure an infant to the patient support platform and at least one supply system support built into the patient support platform.

16. The patient support platform as defined in claim 15 wherein the patient support platform further includes a support base having a plurality of stops formed therein and wherein the bed height adjusting system includes a pair of handles pivotally affixed to the patient support that interfit into a desired one of the plurality of stops to adjust the height of one or both ends of the patient support platform.

17. The patient support platform as defined in claim 15 wherein the molded base comprises a main section and a head section at one end thereof and wherein the head section is removable to access the head of an infant when positioned on the patient support platform.

18. The patient support platform as defined in claim 16 wherein the at least one supply system support is molded into one of the handles.
